(19) United States
(12) Patent Application Publication
(10) Pub. No.: US 2017/0000170 A1
(43) Pub. Date: Jan. 5, 2017

(54) POPPED SNACK

(71) Applicant: INTERCONTINENTAL GREAT BRANDS LLC, East, Hanover, NJ (US)

(72) Inventors: Karen FREYRE, East Hanover, NJ (US); Stephanie M. BOYD, East Hanover, NJ (US)

(73) Assignee: Intercontinental Great Brands LLC, East Hanover, NJ (US)

(21) Appl. No.: 15/038,946

(22) PCT Filed: Nov. 25, 2014
(86) PCT No.: PCT/US14/67306

§ 371 Date: May 24, 2016

Related U.S. Application Data
(60) Provisional application No. 61/908,670, filed on Nov. 25, 2013.

(51) Int. Cl. A23L 7/161; A23L 7/10

(52) U.S. Cl. CPC A23L 7/161; A23L 7/115; A23V 2002/00

(57) ABSTRACT

A popped snack product including a whole grain wheat component including a bran component having a particle size distribution such that at least 70 wt % of particles pass a 212 micrometer sieve. In some embodiments, the whole grain wheat component is present in an amount of at least 20 wt % finished product; 20 wt % to 25 wt % of the finished product; or about 23 wt % of the finished product.

### CROSS-REFERENCE TO RELATED APPLICATIONS

This application claims the benefit of U.S. Provisional Patent Application No. 61/908,670 filed Nov. 25, 2013 entitled “Popped Snack”, which is incorporated by reference herein in its entirety.

### BACKGROUND OF THE INVENTION

The present invention generally relates to a popped or puffed foodstuff. Popped products can be made, for example, by charging a chamber with manufactured half products or pellets such as those produced in accordance with U.S. Pat. No. 4,844,937 which is hereby incorporated by references as if set forth in its entirety herewith. The manufactured half products or pellets are subjected to heat and pressure. Upon the release of the pressure, the half products or pellets rapidly expand to form the popped snack. Whole grains are a desirable to consumers. Whole grain wheat in particular is desirable to a consumer. Popped snacks with whole grain wheat, however can lack the organoleptic properties that consumers enjoy in popped snacks.

### BRIEF SUMMARY OF THE INVENTION

According to some embodiments of the present invention, a popped snack product includes a whole grain wheat component having a bran component with a particle size distribution such that at least 70 wt % of particles pass a 212 μm sieve.

According to some embodiments of the present invention, a popped snack product includes a whole grain wheat component having a bran component with a particle size distribution such that 70 wt % to 80 wt % of particles pass a 212 μm sieve.

In some embodiments, the whole grain wheat component is present in an amount of at least 20 wt % finished product; 20 wt % to 25 wt % of the finished product; or about 23 wt % of the finished product.

In certain embodiments, the bran component is present in amount of 3 wt % to 15 wt % of the finished product; 8 wt % to 18 wt % of the finished product; or about 9.5 wt % of the finished product. In some embodiments, the bran component comprises bran, germ and starch. In some embodiments, the bran component comprises at least 50 wt % bran. In some embodiments, the bran component comprises 10 wt % to 40 wt % starch. In some embodiments, the bran component consists essentially of bran. In some embodiment embodiments, the bran component consists essentially of bran and germ.

In some embodiments, the whole grain wheat component provides about 25% to about 35% of the total protein in the popped snack. In certain embodiments, the popped snack has a density of about 0.18 g/ml to about 0.4 g/ml.

### BRIEF DESCRIPTION OF THE SEVERAL VIEWS OF THE DRAWINGS

The foregoing summary, as well as the following detailed description of certain embodiments of the food product will be better understood when read in conjunction with the following exemplary embodiments and the appended drawings.

FIG. 1 shows a top perspective view of an embodiment of the present invention.

FIG. 2 shows a top view of the embodiment of FIG. 1.

FIG. 3 a bottom view of the embodiment of FIG. 1.

FIG. 4 shows a front view of the embodiment of FIG. 1.

FIG. 5 shows a back view of the embodiment of FIG. 1.

FIG. 6 shows a right view of the embodiment of FIG. 1.

FIG. 7 shows a left view of the embodiment of FIG. 1.

FIG. 8 shows a top perspective view of an embodiment of the present invention.

FIG. 9 shows a top view of the embodiment of FIG. 7.

FIG. 10 shows a bottom view of the embodiment of FIG. 7.

FIG. 11 shows a front view of the embodiment of FIG. 7.

FIG. 12 shows a back view of the embodiment of FIG. 7.

FIG. 13 shows a right view of the embodiment of FIG. 7.

FIG. 14 shows a left view of the embodiment of FIG. 7.

FIG. 15 shows a top perspective view of an embodiment of the present invention.

FIG. 16 shows a top view of the embodiment of FIG. 15.

FIG. 17 a bottom view of the embodiment of FIG. 15.

FIG. 18 shows a front view of the embodiment of FIG. 15.

FIG. 19 shows a back view of the embodiment of FIG. 15.

FIG. 20 shows a right view of the embodiment of FIG. 15.

FIG. 21 shows a left view of the embodiment of FIG. 15.

FIG. 22 shows a top perspective view of an embodiment of the present invention.

FIG. 23 shows a top view of the embodiment of FIG. 22.

FIG. 24 a bottom view of the embodiment of FIG. 22.

FIG. 25 shows a front view of the embodiment of FIG. 22.

FIG. 26 shows a back view of the embodiment of FIG. 22.

FIG. 27 shows a right view of the embodiment of FIG. 22.

FIG. 28 shows a left view of the embodiment of FIG. 22.

FIG. 29 shows a top perspective view of an embodiment of the present invention.

FIG. 30 shows a top view of the embodiment of FIG. 29.

FIG. 31 a bottom view of the embodiment of FIG. 29.

FIG. 32 shows a front view of the embodiment of FIG. 29.

FIG. 33 shows a back view of the embodiment of FIG. 29.

FIG. 34 shows a right view of the embodiment of FIG. 29.

FIG. 35 shows a left view of the embodiment of FIG. 29.

FIG. 36 shows a top perspective view of an embodiment of the present invention.

FIG. 37 shows a top view of the embodiment of FIG. 36.

FIG. 38 a bottom view of the embodiment of FIG. 36.

FIG. 39 shows a front view of the embodiment of FIG. 36.

FIG. 40 shows a back view of the embodiment of FIG. 36.

FIG. 41 shows a right view of the embodiment of FIG. 36.

FIG. 42 shows a left view of the embodiment of FIG. 36.

### DETAILED DESCRIPTION OF THE INVENTION

Compositions and methods of some embodiments of the present invention relate to a popped snack product having a flour blend including a whole grain wheat component and a desirable texture. In some embodiments, the popped snack product is formulated to include a flour blend and/or whole grain wheat component particle size distribution which provides a desired texture of the final product. For example, the overall particle size distribution of the flour blend as well as the particle size distribution of one or more of the components within the flour blend, such as the whole grain wheat component, may affect the texture of the finished product. In some embodiments, the particle size of the components may affect the texture of the finished product by allowing the components to either interrupt or become integrated within the gluten and starch network of the finished product. Throughout this application, the percentages expressed are in weight percent (whether references specifically as wt % or as simply %) unless expressly stated otherwise.

In some embodiments, the popped snack products are prepared by compressing starchy material such as half products or pellets. The present embodiments are described for convenience as using manufactured pellets. Other forms of starchy material may be used to take advantage of the invention described herein.

Pellets may include those formed from extruded dough. In some embodiments, the dough may include whole grain such as whole grain wheat flour and/or rice flour. The dough may further include other materials such as, dried potatoes, sugar, salt, and/or other additional ingredients.

In some embodiments, the moisture of the pellets prior to popping is about 8 wt % to about 15 wt %. Popping techniques may include those described in U.S. Pat. No. 4,667,588 of Hayashi which is incorporated by reference in their entirety herein.

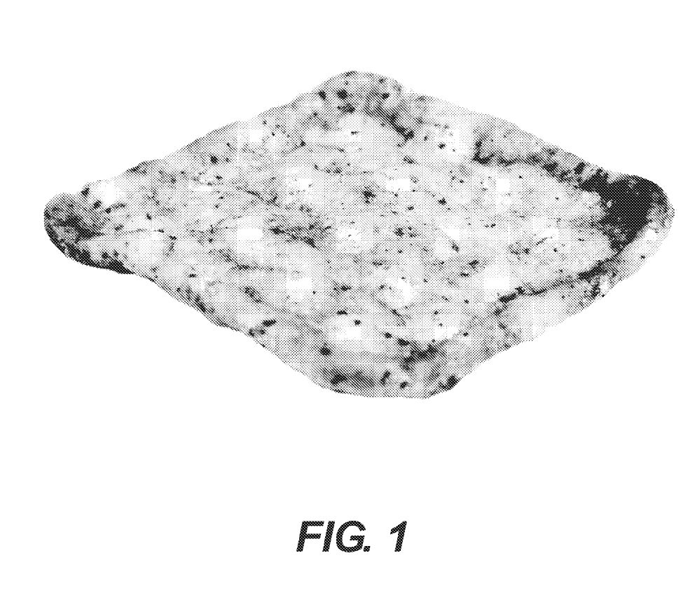

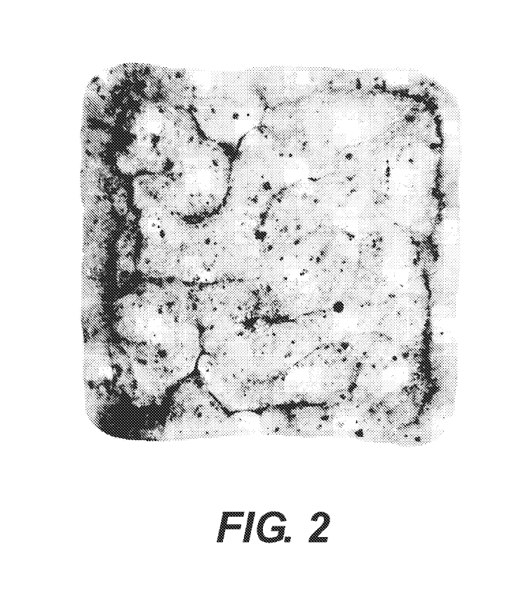

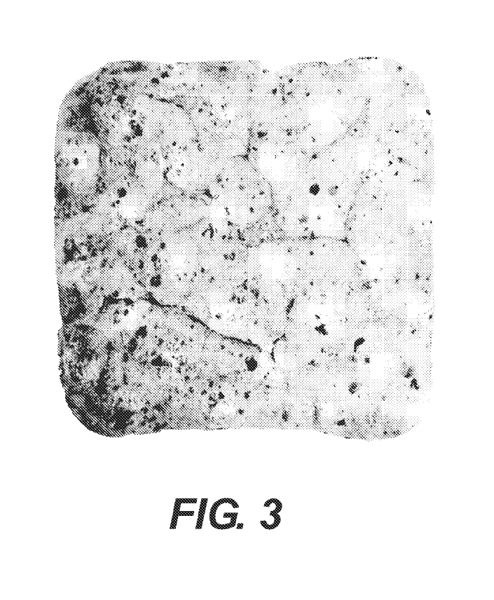

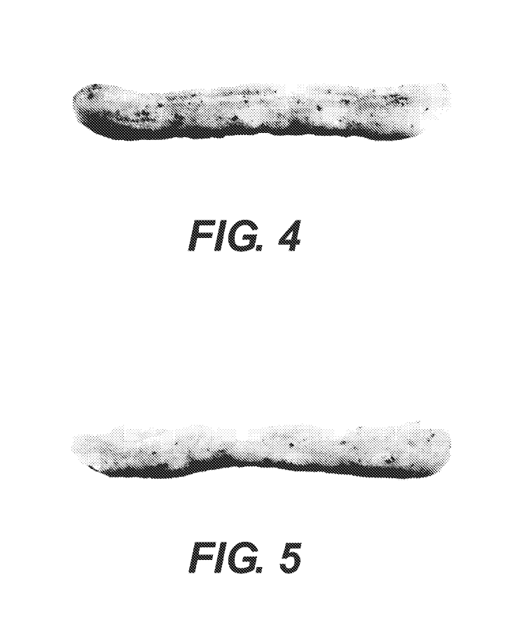

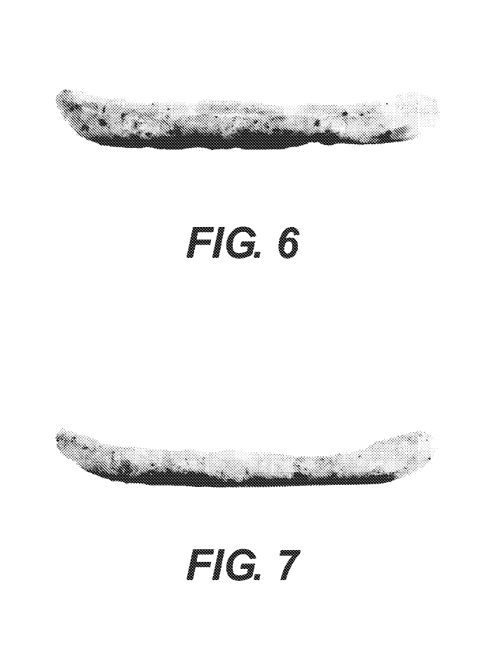

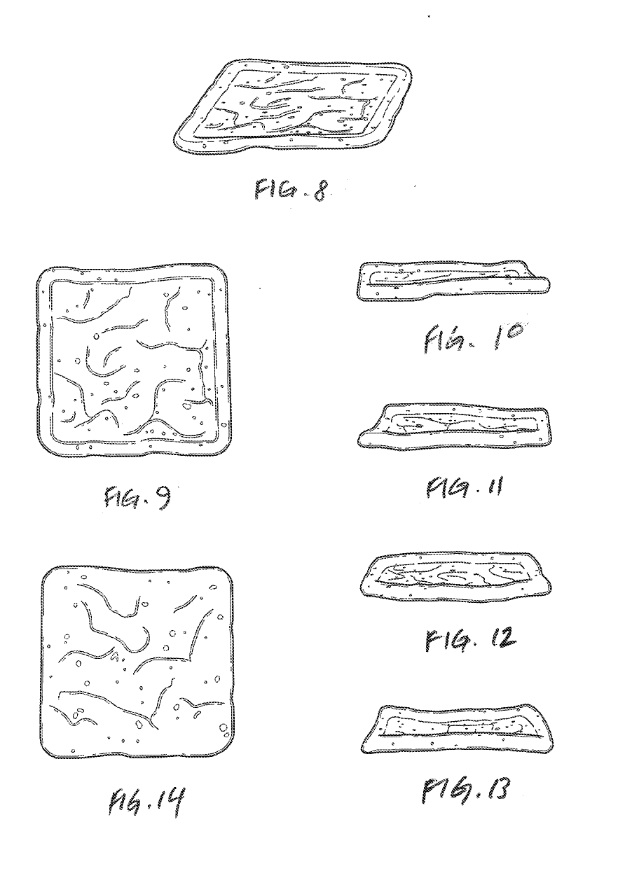

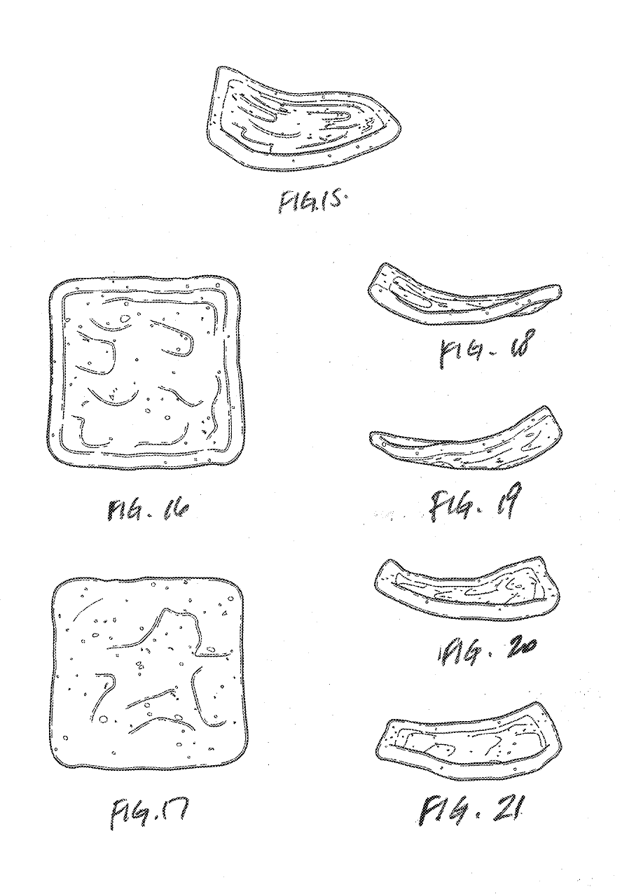

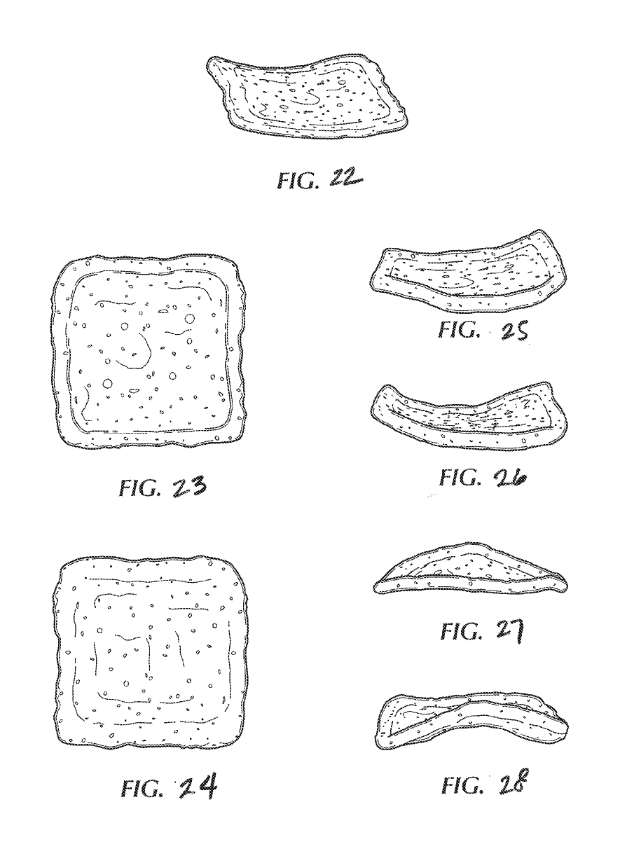

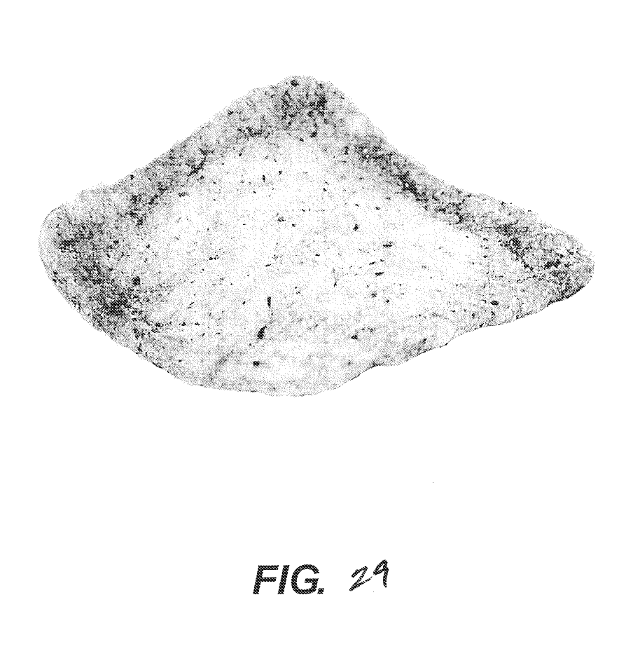

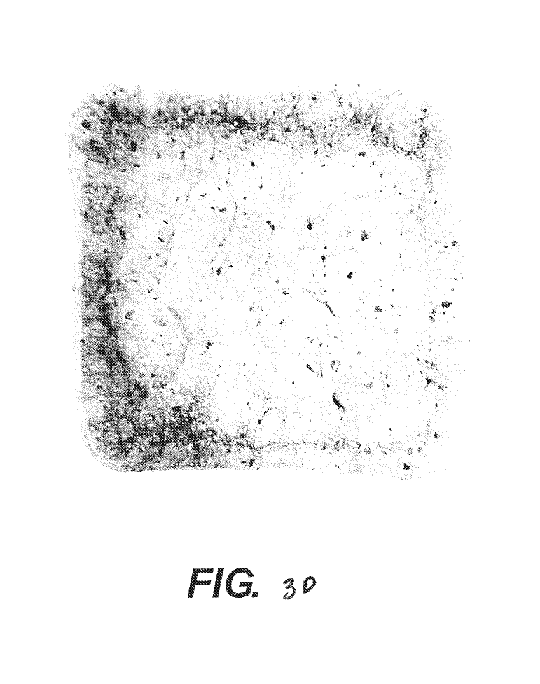

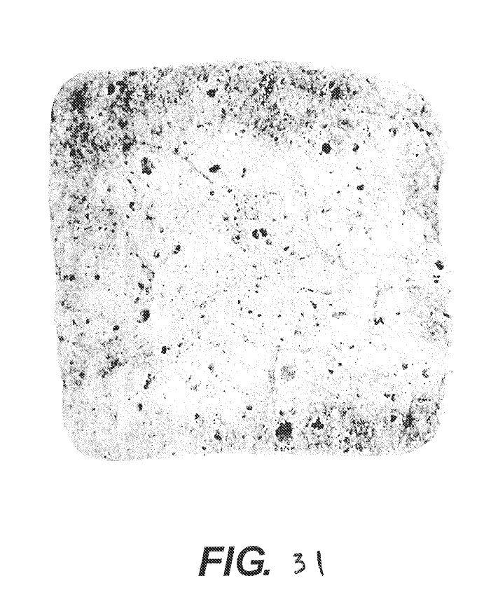

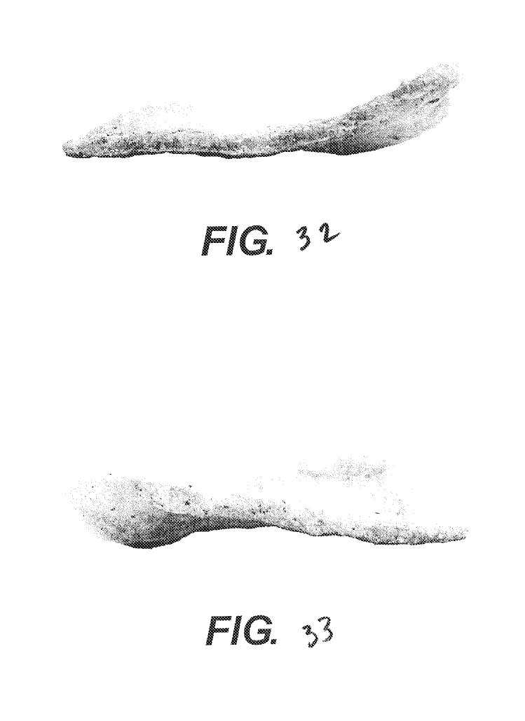

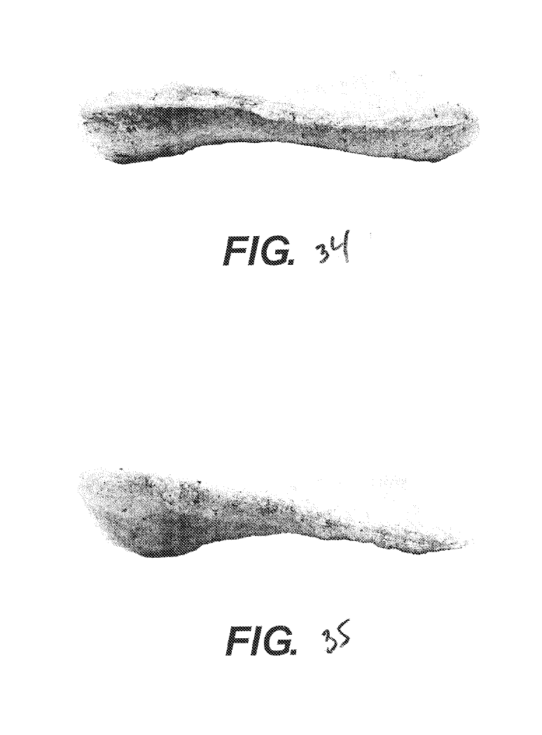

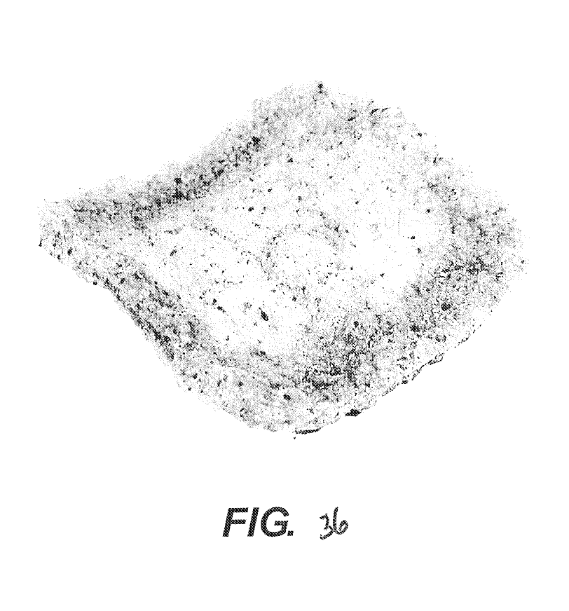

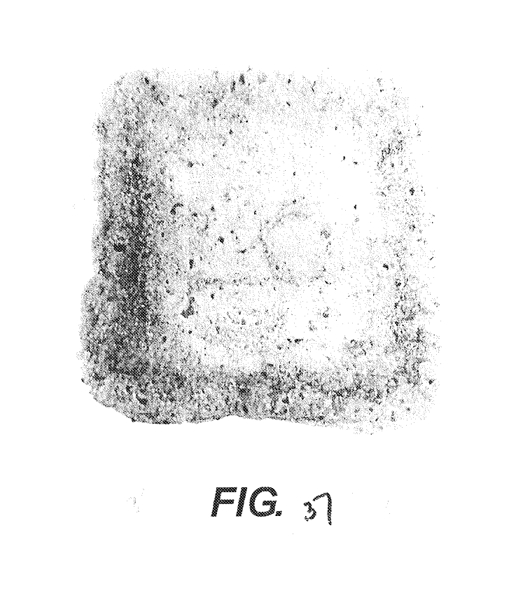

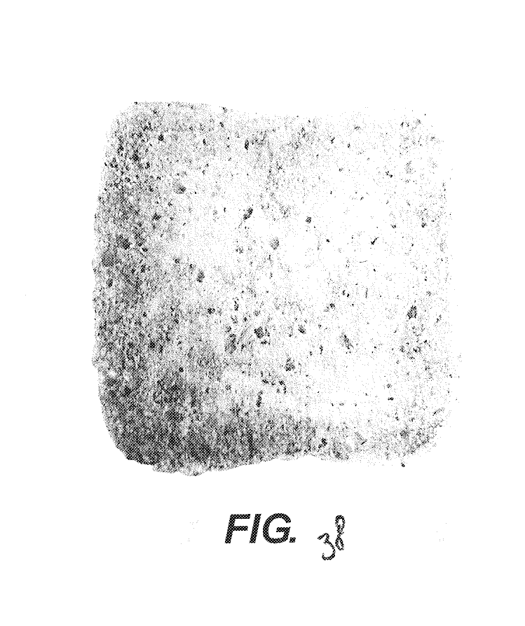

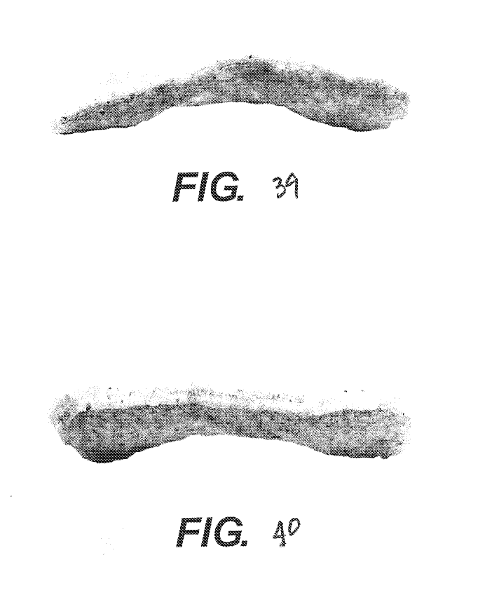

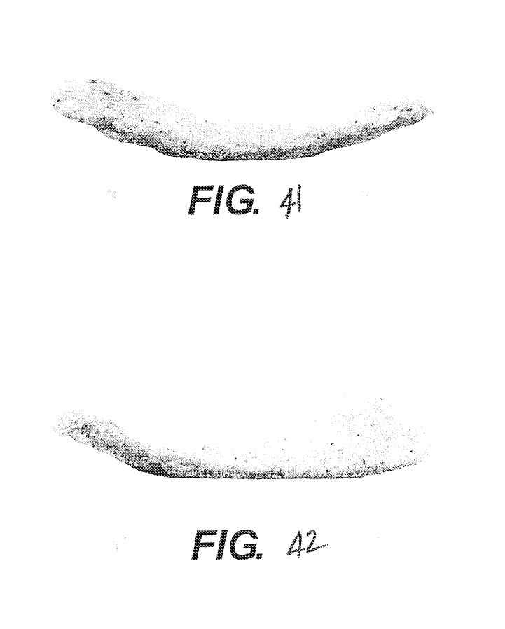

FIGS. 1-7 show a popped snack of one embodiment of the present invention, having ingredients and a particle size distribution to provide a desired texture as described herein. FIGS. 8-14 show a popped snack of one embodiment of the present invention, having ingredients and a particle size distribution to provide a desired texture as described herein. FIGS. 15-21 show a popped snack of one embodiment of the present invention, having ingredients and a particle size distribution to provide a desired texture as described herein. FIGS. 22-28 show a popped snack of one embodiment of the present invention, having ingredients and a particle size distribution to provide a desired texture as described herein. FIGS. 39-35 show a popped snack of one embodiment of the present invention, having ingredients and a particle size distribution to provide a desired texture as described herein. FIGS. 36-42 show a popped snack of one embodiment of the present invention, having ingredients and a particle size distribution to provide a desired texture as described herein.

In order to maximize consumer experience, whole grains of the present invention may include the following characteristics.

Flour Blend

Popped snacks of the present invention may include a flour blend which includes a whole grain wheat component and/or an additional flour component (e.g., an additional wheat flour component). The components of the flour blend are described in further detail below.

Whole Grain Wheat

Popped snack products of the present invention may include a whole grain wheat component. In some embodiments, the whole grain wheat component includes one or more whole grain wheat flour components, which may include a bran component, a germ component, an endosperm component and combinations thereof.

In some embodiments, a popped snack product includes a whole grain wheat component in an amount of about 5 wt % to about 50 wt % of the popped snack product; about 5 wt % to about 45 wt % of the popped snack product; about 5 wt % to about 40 wt % of the popped snack product; about 10 wt % to about 35 wt % of the popped snack product; about 15 wt % to about 30 wt % of the popped snack product; about 20 wt % to about 25 wt % of the popped snack product; about 5 wt % of the popped snack product; about 10 wt % of the popped snack product; about 15 wt % of the popped snack product; about 20 wt % of the popped snack product; at least 20 wt % of the popped snack product; about 23 wt % of the popped snack product; about 25 wt % of the popped snack product; about 30 wt % of the popped snack product; about 35 wt % of the popped snack product; about 40 wt % of the popped snack product; about 45 wt % of the popped snack product; or about 50 wt % of the popped snack product.

In some embodiments, the whole grain wheat component includes a first whole wheat flour component. The first whole wheat flour component may include, for example, soft white wheat. In some embodiments, the first whole wheat flour component may be present in an amount of about 1 wt % to about 50 wt % of the popped snack product; about 1 wt % to about 45 wt % of the popped snack product; about 1 wt % to about 40 wt % of the popped snack product; about 1 wt % to about 35 wt % of the popped snack product; about 1 wt % to about 30 wt % of the popped snack product; about 1 wt % to about 25 wt % of the popped snack product; about 1 wt % to about 20 wt % of the popped snack product; about 5 wt % to about 15 wt % of the popped snack product; about 7 wt % to about 13 wt % of the popped snack product; about 1 wt % of the popped snack product; about 5 wt % of the popped snack product; about 10 wt % of the popped snack product; about 15 wt % of the popped snack product; about 20 wt % of the popped snack product; about 25 wt % of the popped snack product; about 30 wt % of the popped snack product; about 35 wt % of the popped snack product; about 40 wt % of the popped snack product; about 45 wt % of the popped snack product; or about 50 wt % of the popped snack product.

In certain embodiments, the whole grain wheat component may also include a second whole wheat flour component. The second whole wheat flour component may include a whole wheat flour source that is different from the source of the first whole wheat flour component. In certain embodiment, one or both of the first and second whole wheat flour components may be soft red wheat, soft white wheat and combinations thereof. In one embodiment, one of the first and second whole wheat four components is soft red wheat and the other is soft white wheat. Either or both of the first whole wheat flour component and the second whole wheat flour component may be a flour described in International Publication Number WO 2012/148543, U.S. Pat. No. 8,017,172, CA 2,141,974, and U.S. Pat. No. 3,100,708, the contents of which are each hereby incorporated by reference in their entirety herewith.

In some embodiments, the second whole wheat flour component may be present in an amount of about 1 wt % to about 50 wt % of the popped snack product; about 1 wt % to about 45 wt % of the popped snack product; about 1 wt % to about 40 wt % of the popped snack product; about 1 wt % to about 35 wt % of the popped snack product; about 1 wt % to about 30 wt % of the popped snack product; about 1 wt % to about 25 wt % of the popped snack product; about 5 wt % to about 20 wt % of the popped snack product; about 7 wt % to about 18 wt % of the popped snack product; about 10 wt % to about 15 wt % of the popped snack product; about 1 wt % of the popped snack product; about 5 wt % of the popped snack product; about 10 wt % of the popped snack product; about 15 wt % of the popped snack product; about 20 wt % of the popped snack product; about 25 wt % of the popped snack product; about 30 wt % of the popped snack product; about 35 wt % of the popped snack product; about 40 wt % of the popped snack product; about 45 wt % of the popped snack product; or about 50 wt % of the popped snack product.

Additional Flour Component

In certain embodiments, the flour component may also include a component such as a third wheat flour component that may or may not be a whole wheat flour component. In one embodiment, the third wheat flour component may include one of the flours disclosed in International Publication Number WO 2012/148543. In certain embodiments, the third wheat flour component may include flour that is substantially derived from endosperm. The third wheat flour component may include no or very little bran. In some embodiments, the third wheat flour component may include no or very little germ. In one embodiment, the third wheat flour component may be a medium wheat flour that is enriched. The third wheat flour component may be milled from a blend of soft and hard wheat. In one embodiment, the third wheat flour component may be enriched to meet relevant government regulations for enriched flour.

In some embodiments, the third wheat flour component may be present in an amount of about 1 wt % to about 50 wt % of the popped snack product; about 1 wt % to about 45 wt % of the popped snack product; about 1 wt % to about 40 wt % of the popped snack product; about 1 wt % to about 35 wt % of the popped snack product; about 1 wt % to about 30 wt % of the popped snack product; about 1 wt % to about 25 wt % of the popped snack product; about 5 wt % to about 20 wt % of the popped snack product; about 7 wt % to about 18 wt % of the popped snack product; about 10 wt % to about 15 wt % of the popped snack product; about 1 wt % of the popped snack product; about 5 wt % of the popped snack product; about 10 wt % of the popped snack product; about 15 wt % of the popped snack product; about 20 wt % of the popped snack product; about 25 wt % of the popped snack product; about 30 wt % of the popped snack product; about 35 wt % of the popped snack product; about 40 wt % of the popped snack product; about 45 wt % of the popped snack product; or about 50 wt % of the popped snack product.

In some embodiments, the popped snack of the present invention is created from manufactured pellets having a ratio of first whole wheat flour component to second whole wheat flour component to third flour component (referred to herein as a flour ratio) that is (or is about) 1:1.5:1.5. In another embodiment the flour ratio is (or is about) 1:2:2. In another embodiment the flour ratio is (or is about) 1:1.4:1.4. In another embodiment the flour ratio is (or is about) 1:1.3:1.3. In another embodiment the flour ratio is (or is about) 1:1.5:1.4.

Particle Size Distribution

In some embodiments, the composition of the flour blend is selected in order to provide a particle size distribution resulting in a desired texture of the finished product. For example, the overall particle size distribution of the flour blend as well as the particle size distribution of one or more of the components within the flour blend may be selected to affect the texture of the finished product.

Without wishing to be bound by theory, it is believed that granules such as manufactured pellets, half-products and whole grains that have a significant fiber component are a challenge to use in a puffing chamber to produce desirable consumer products. It is believed that the fiber may interfere with expansion. In some embodiments, it may be the particle size of the components that affect the texture of the finished product by, for example, allowing the components or constituents of the components to either interrupt or become integrated within the gluten and starch network of the finished product. For example, where a gluten network is formed from a starch and protein component, bran particles of a large enough size can disrupt the continuity of the gluten network and therefore impact texture.

It is desirable however, to produce a whole grain wheat-based popped product. In one embodiment, the flours used to manufacture granules (e.g., pellets or half products) for popping include a bran and/or germ component that has been finely ground. In one embodiment, the bran and/or germ portion are finely ground to more closely resemble the particle sizes of an endosperm component to which it is recombined to produce the whole grain flour. In one embodiment, coarse bran particles act as inert plates which can interfere with the gluten and starch network formed during extrusion and/or popping. Whereas much of the starchy pellet would be expected to gelatinize during popping, the bran component would not be expected to gelatinize. Instead, in some embodiments, bran would simply swell slightly during extrusion and/or popping. By using finely ground bran particles, however, it is believed that the particles are better integrated into the gluten and starch network. Such integration may create an organoleptically pleasing texture to the popped finished product despite the presence of whole grain wheat. It is further believed that the effect of the introduction of coarse bran components into a granule to be popped would have a greater effect on the texture than even if such a coarse fraction were incorporated into traditional baked good such as a cracker. Because, in some embodiments, the air cells in a popped snack are much larger than in a traditional baked good, the effect of coarse bran is magnified because there is more opportunity for the bran to disrupt the network encapsulating the expanding air cell. By introducing the bran fraction (or at least a portion of the bran fraction) in a finely ground condition, less disruption to air cells, networks and layers would be expected and there may be a greater degree of uniformity within the networks that surround the expanding air cells during puffing.

A desirable texture therefore may be selected by controlling one or more particle size characteristics of one or more components of the flour blend. The particle size characteristics of the overall whole flour blend, a whole grain wheat flour component, a bran component, a germ component, an endosperm component and combinations thereof (e.g., a bran/germ component) that is selected to produce a desired texture in the finished popped product may include, for example, particle size (e.g., maximum particle size, minimum particle size) and/or particle size distribution characteristics such as mode, modality (e.g., unimodal distributions, multimodal distributions, bi-modal distributions, gap-graded distributions and the like), mean particle size, median particle size, distribution width characteristics (e.g., D10, D50, D90), span (i.e., (D90−D10)/D50), pan), percent of particles smaller than a specific size, and percent of particles larger than a specific size. Combinations of each of the foregoing parameters may further be selected to produce the desirable texture in the finished product.

Particle Size Distribution

In some embodiments, the flour blend has an overall particle size distribution characterized by at least 70 wt % of particles passing through a No. 70 (212 micron) U.S. Standard Sieve; 70 wt % to 80 wt % of particles pass through a No. 70 (212 micron) U.S. Standard Sieve; or 70 wt % to 75 wt % of particles pass through a No. 70 (212 micron) U.S. Standard Sieve. In some embodiments, the flour blend has an overall particle size distribution characterized up to 30 wt % of particles are retained on a No. 70 (212 micron) U.S. Standard Sieve; 20 wt % to 30 wt % of particles are retained on a No. 70 (212 micron) U.S. Standard Sieve; or 25 wt % to 30 wt % of particles are retained on a No. 70 (212 micron) U.S. Standard Sieve.

Particle Size Distribution of First Whole Wheat Flour Component

In some embodiments, the first whole grain wheat flour component has a particle size distribution characterized by a) about 0% by weight of the particles are retained on a #35 (500 micron) sieve and b) less than or equal to about 20% by weight, less than or equal to about 10% by weight, or less than or equal to about 5% by weight is retained on a #70 (210 micron) U.S. Standard Sieve. In some embodiments, the whole grain wheat component includes a first whole grain wheat flour component characterized by a particle size distribution of up to about 100% by weight passing through a No. 70 (210 micron) U.S. Standard Sieve. In some embodiments, the whole grain wheat component includes a first whole grain wheat flour component characterized by a particle size distribution where a) at least 75% by weight, at least 85% by weight, and/or from about 90% by weight to about 98% by weight is less than or equal to 149 microns, and b) less than or equal to 5% by weight greater than 250 microns.

Particle Size Distribution of the Second Whole Wheat Flour Component

In one embodiment, the second whole wheat flour component has a particle size distribution that is selected to achieve a particular particle size distribution of the flour blend and/or the whole wheat component based on the particle size distribution of the first whole wheat component.

Bran Component

In certain embodiments, the first whole wheat flour component and/or the second whole wheat flour component includes a bran component. In certain embodiments, the bran component has portions taken from the group that includes bran, germ, starch (e.g., endosperm) and combinations thereof. In some embodiments, the bran component consists essentially of bran, germ and starch. In other embodiments, the bran component consists essentially of bran and germ. In some embodiments, the bran component is substantially all bran and germ; the starch (e.g., endosperm) portion of the bran component being in trace quantities which is in some cases due to manufacturing imprecision. In still other embodiments, the bran component consists essentially of bran. In some embodiments, the bran component is substantially all bran, there being only very small quantities of germ and/or endosperm present. In some embodiments, the bran component is at least 50 wt % bran. In some embodiments, the bran component is 10 wt % to 40 wt % starch.

In some embodiments, the popped snack includes a bran component in an amount of 3 wt % to 15 wt % of the finished product; 8 wt % to 12 wt % of the finished product; or 9.5 wt % of the finished product.

Amount of Bran in First and/or Second Whole Wheat Flour Component.

Although described in the context of the first whole wheat flour component, the bran component may be present in the first and/or second whole wheat flour component in an amount of: from 10 wt % to 50 wt % of the first and/or second whole wheat flour component respectively, from 10 wt % to 40 wt % of the first and/or second whole wheat flour component respectively, from 10 wt % to 30 wt % of the first and/or second whole wheat flour component respectively, from 10 wt % to 20 wt % of the first and/or second whole wheat flour component respectively, from 20 wt % to 50 wt % of the first and/or second whole wheat flour component respectively, from 20 wt % to 40 wt % of the first and/or second whole wheat flour component respectively, from 20 wt % to 30 wt % of the first and/or second whole wheat flour component respectively, or from 25 wt % to 35 wt % of the first and/or second whole wheat flour component respectively.

The bran component may be present in the first and/or second whole wheat flour component in an amount of about 10%, about 20%, about 30%, about 45% or about 50%.

The amount of bran in the bran component may be at least 50% by weight, and the amount of starch (e.g., endosperm) may be from 10% by weight to 40% by weight, based upon the weight of the bran component.

In certain embodiments, the particle size of the bran component is selected to have a particle size distribution such that up to 15 wt % is retained on the No. 35 (500 μm) U.S. Standard Sieve. In one embodiment, greater than or equal to 75 wt % of the bran component has a projection of less than or equal to 149 microns.

In one embodiment, the second whole wheat flour component includes a bran component with a particle size distribution that is selected to achieve a particular particle size distribution of the overall bran component based on the particle size distribution of the bran component in the first whole wheat flour component.

Overall Bran Component Particle Size Distribution

In some embodiments, the whole grain wheat component includes a bran component which may include a combination of the bran component of the first whole wheat flour component and the bran component of second whole wheat flour component. The overall bran component may be selected such that a selected portion of the bran component is of a size that integrates within the gluten network of the finished product without substantially disrupting it (or disrupting it to a desirable degree). The overall bran component may further include a fraction of bran component that is coarser and would, to some degree, disrupt the gluten network as described herein. In one embodiment, combining the coarse fraction bran component and the fine fraction bran component strikes a desirable balance between a smooth crunchy popped chip and popped chip with some gritty, mealy attributes.

In some embodiments, the whole grain wheat component includes a bran component with a particle size distribution characterized by at least 70 wt % of particles passing through a No. 70 (212 micron) U.S. Standard Sieve; 70 wt % to 80 wt % of particles pass through a No. 70 (212 micron) U.S. Standard Sieve; or 70 wt % to 75 wt % of particles pass through a No. 70 (212 micron) U.S. Standard Sieve. In some embodiments, the whole grain wheat component includes a bran component with a particle size distribution characterized up to 30 wt % of particles are retained on a No. 70 (212 micron) U.S. Standard Sieve; 20 wt % to 30 wt % of particles are retained on a No. 70 (212 micron) U.S. Standard Sieve; or 25 wt % to 30 wt % of particles are retained on a No. 70 (212 micron) U.S. Standard Sieve.

In some embodiments, the whole grain wheat component includes a bran component with a particle size distribution characterized by a bi-modal distribution. Two peaks in the bi-modal distribution may be the result of two bran components from two whole wheat flour components.

Bran and Germ Particle Size Distribution

In some embodiments, the whole grain wheat component includes a bran and germ component wherein the maximum particle size of the bran component is substantially the same as the maximum particle size of the endosperm component.

Protein

In some embodiments, a popped snack is formulated to achieve desired protein levels. Various types of flour may provide different levels of protein; even among wheat flour, different types of wheat flour may contain varying levels of protein. In some embodiments, a popped snack includes a flour component that provides a desired amount of protein. In some embodiments, flours such as rice and/or potato flour may provide lower levels of protein than whole wheat flours. In some embodiments, a popped snack includes a first flour component which provides protein in an amount of about 1.6 g per serving to about 3.2 g per serving; about 1.8 g per serving to about 3 g per serving; about 2 g per serving to about 2.8 g per serving; about 2.2 g per serving to about 2.6 g per serving; about 1.6 g per serving; about 1.8 g per serving; about 2 g per serving; about 2.2 g per serving; about 2.4 g per serving; about 2.6 g per serving; about 2.8 g per serving; about 3 g per serving; or about 3.2 g per serving. In some embodiments, a first flour component provides about 10% to about 50% of the total protein in the popped snack; about 20% to about 40% of the total protein in the popped snack; about 25% to about 35% of the total protein in the popped snack; about 10% of the total protein in the popped snack; about 20% of the total protein in the popped snack; about 25% of the total protein in the popped snack; about 30% of the total protein in the popped snack; about 35% of the total protein in the popped snack; about 40% of the total protein in the popped snack; or about 50% of the total protein in the popped snack. In some embodiments, this first flour component is whole grain wheat.

In some embodiments, a popped snack includes protein in a total amount of about 3 g per serving to about 12 g per serving; about 5 g per serving to about 10 g per serving; about 7 g per serving to about 8 g per serving; about 3 g per serving; about 5 g per serving; about 7 g per serving; about 9 g per serving; about 11 g per serving; or about 13 g per serving.

Density

In some embodiments, the desirable texture associated with popped snacks of the present invention may be characterized by density values. In some embodiments, popped snacks of the present invention may have a higher density than popped snacks which do not contain whole grain wheat flour according to embodiments of the present invention. While not wishing to be bound by theory, it is believed that popped snacks including whole grain wheat flour according to embodiments of the present invention have a higher density, and the associated desirable texture, than a comparative product containing, for example, only potato flour because of properties associated with the respective types of flour. Such properties may include formation of gluten networks within the product. In some embodiments, popped snacks of the present invention may have a density of about 0.18 g/ml to about 0.4 g/ml; about 0.18 g/ml to about 0.39 g/ml; about 0.18 g/ml to about 0.37 g/ml; about 0.18 g/ml to about 0.35 g/ml; about 0.19 g/ml to about 0.33 g/ml; about 0.21 g/ml to about 0.31 g/ml; about 0.23 g/ml to about 0.29 g/ml; about 0.25 g/ml to about 0.27 g/ml; about 0.17 g/ml; about 0.18 g/ml; about 0.19 g/ml; about 0.2 g/ml; about 0.22 g/ml; about 0.24 g/ml; about 0.26 g/ml; about 0.28 g/ml; about 0.3 g/ml; about 0.32 g/ml; about 0.34 g/ml; about 0.36 g/ml; about 0.38 g/ml; or about 0.4 g/ml.

### Example 1

Manufactured Pellets were produced using flour that included a wheat flour component having a whole wheat fraction and an enriched wheat flour fraction. The whole wheat had a particle size distribution such that 70 wt % to 75 wt % of the particles passed a 212 μm sieve. The wheat flour component with both the whole wheat fraction and the enriched wheat flour fraction also had a particles size distribution such that 70 wt % to 75 wt % of the particles passed a 212 μm sieve.

### Example 2

Pellets for popping in a cereal popping machine were prepared with a wheat flour blend in an amount of about 30 wt % to about 40 wt % of the overall pellet. The pellets included whole wheat in an amount of about 20 wt % to about 25 wt %; other starchy flours (such as, for example, potato flour, sweet potato flour, rice flour, buckwheat flour, barley flour, corn flour, lentil flour, quinoa flour, etc) in an amount of about 50 wt % to about 60 wt %; and additional ingredients including flavoring agents (e.g., sweetener, salts, manufactured flavoring compositions), antioxidants, and dough conditioning agents. The pellets were charged in a popping chamber and popped to produce a desirable product with a 1 gram weight.

### Example 3

A popped snack according to embodiments of the present invention was prepared with a formulation including whole grain wheat. A comparative product prepared with a formulation including potato flour, and no wheat, was obtained. Both products were tested for volume and specific volume values and compared.

The tests were conducted using a Volscan Profiler. A gold coating was applied to the samples in order to increase surface reflection and improve the quality of the scan. Scans were performed on ten samples of the popped snack and ten samples of the comparative product.

The Volscan Profiler measures volume by scanning the sample with a laser while the sample is rotated at 1 rpm. A three-dimensional image is obtained, and volume is measured to 3 dp. The mass is measured as well, and density is then calculated as mass/volume.

The measurements and calculations for the samples is included in the table below:

As demonstrated in the results, the popped snack including whole grain wheat flour has a significantly higher density than the comparative product, which contains only potato flour. While not wishing to be bound by theory, it is believed that popped snacks including whole grain wheat flour according to embodiments of the present invention have a higher density, and the associated desirable texture, than a comparative product containing only potato flour because of properties associated with the respective types of flour such as, for example, formation of gluten networks within the product.

| | | | | Specific | Specific |
|---|---|---|---|---|---|
| | | Volume | Weight | Volume | Volume |
| | | (ml) | (g) | (g/ml) | (ml/g) |
| Popped | | | | | |
| Snack with | | | | | |
| Wheat | | | | | |
| Samples | | | | | |
| 1 | | 3.983 | 1.173 | 0.295 | 3.396 |
| 2 | | 5.895 | 1.184 | 0.201 | 4.979 |
| 3 | | 4.659 | 1.307 | 0.281 | 3.564 |
| 4 | | 5.626 | 1.262 | 0.224 | 4.457 |
| 5 | | 4.962 | 1.116 | 0.225 | 4.444 |
| 6 | | 4.716 | 1.2 | 0.254 | 3.931 |
| 7 | | 4.269 | 1.132 | 0.265 | 3.771 |
| 8 | | 4.842 | 1.328 | 0.274 | 3.645 |
| 9 | | 4.454 | 1.194 | 0.268 | 3.73 |
| 10 | | 4.308 | 1.145 | 0.266 | 3.763 |
| | Average | 4.771 | 1.204 | 0.255 | 3.968 |
| | S.D. | 0.6 | 0.07 | 0.029 | 0.497 |
| | C.O.V. (%) | 12.57 | 6.02 | 11.50 | 12.52 |
| Comparative | | | | | |
| Samples | | | | | |
| 1 | | 7.669 | 1.161 | 0.151 | 6.606 |
| 2 | | 9.092 | 1.26 | 0.139 | 7.216 |
| 3 | | 9.613 | 1.14 | 0.119 | 8.432 |
| 4 | | 6.931 | 1.15 | 0.166 | 6.027 |
| 5 | | 9.811 | 1.242 | 0.127 | 7.899 |
| 6 | | 9.075 | 1.201 | 0.132 | 7.556 |
| 7 | | 9.99 | 1.133 | 0.113 | 8.817 |
| 8 | | 7.09 | 1.215 | 0.171 | 5.835 |
| 9 | | 7.893 | 1.243 | 0.157 | 6.350 |
| 10 | | 9.345 | 1.133 | 0.121 | 8.248 |
| | Average | 8.66 | 1.19 | 0.140 | 7.299 |
| | S.D. | 1.13 | 0.05 | 0.021 | 1.058 |
| | C.O.V. (%) | 12.99 | 4.1 | 14.80 | 14.49 |

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

As used herein, the term “about” is understood to mean ±10% of the value referenced. For example, “about 45%” is understood to literally mean 40.5% to 49.5%.

The claims directed to the method of the present invention should not be limited to the performance of their steps in the order written except where expressly stated, and one skilled in the art can readily appreciate that the steps may be varied and still remain within the spirit and scope of the present invention.

1. A popped snack product comprising:
a whole grain wheat component including a bran component having a particle size distribution such that at least 70 wt % of particles pass a 212 μm sieve.

2. A popped snack product comprising:
a whole grain wheat component including a bran component having a particle size distribution such that 70 wt % to 80 wt % of particles pass a 212 μm sieve.

3. The popped snack product of claim 1, wherein the whole grain wheat component is present in an amount of at least 20 wt % finished product.

4. The popped snack product of claim 1, wherein the whole grain wheat component is present in an amount of 20 wt % to 25 wt % of the finished product.

5. The popped snack product of claim 1, wherein the whole grain wheat component is present in an amount of about 23 wt % of the finished product.

6. The popped snack product of claim 1, wherein the bran component is present in amount of 3 wt % to 15 wt % of the finished product.

7. The popped snack product of claim 1, wherein the bran component is present in amount of 8 wt % to 12 wt % of the finished product.

8. The popped snack product of claim 1, wherein the bran component is present in amount of about 9.5 wt % of the finished product.

9. The popped snack product of claim 1, wherein the bran component comprises bran, germ and starch.

10. The popped snack product of claim 1, wherein the bran component comprises at least 50 wt % bran.

11. The popped snack product of claim 1, wherein the bran component comprises 10 wt % to 40 wt % starch.

12. The popped snack product of claim 1, wherein the bran component consists essentially of bran.

13. The popped snack product of claim 1, wherein the bran component consists essentially of bran and germ.

14. The popped snack of claim 1, wherein the whole grain wheat component provides about 25% to about 35% of total protein in the popped snack.

15. The popped snack of claim 1, wherein the popped snack has a density of about 0.18 g/ml to about 0.4 g/ml.

16. The popped snack product of claim 3, wherein the bran component is present in amount of 3 wt % to 15 wt % of the finished product.

17. The popped snack product of claim 16, wherein the bran component comprises bran, germ and starch.

18. The popped snack of claim 17, wherein the whole grain wheat component provides about 25% to about 35% of total protein in the popped snack.

19. The popped snack of claim 18, wherein the popped snack has a density of about 0.18 g/ml to about 0.4 g/ml.
